(19) United States
(12) Patent Application Publication
(10) Pub. No.: US 2025/0117877 A1
(43) Pub. Date: Apr. 10, 2025

(54) FISHEYE IMAGE PROCESSING METHOD, ELECTRONIC DEVICE, AND COMPUTER-READABLE STORAGE MEDIUM

(71) Applicant: Shenzhen Reolink Technology Co., Ltd., Shenzhen (CN)

(72) Inventors: Xiaoyu Liu, Shenzhen (CN); Sheng Yong, Shenzhen (CN); Xuezheng Yang, Shenzhen (CN)

(21) Appl. No.: 18/987,079

(22) Filed: Dec. 19, 2024

Related U.S. Application Data
(63) Continuation-in-part of application No. PCT/CN2024/078844, filed on Feb. 27, 2024.

(30) Foreign Application Priority Data
Feb. 28, 2023 (CN) 202310229365.0

(51) Int. Cl. G06T 3/047; G06T 5/20; G06T 5/80; G06T 7/13; G06T 7/90

(52) U.S. Cl. CPC G06T 3/047; G06T 5/20; G06T 5/80; G06T 7/13; G06T 7/90; G06T 2207/10024; G06T 2207/20032

(57) ABSTRACT

This application provides a fisheye image processing method, an electronic device, and a computer-readable storage medium. The method includes: acquiring a fisheye image; generating a grayscale image according to the fisheye image; generating a first gradient image in a horizontal direction and a second gradient image in a perpendicular direction; generating an azimuthal image according to the first gradient image and the second gradient image; and determining an effective imaging area according to the azimuthal image. The anti-distortion correction for the fisheye camera is performed in the process of shooting images according to the effective imaging area of the fisheye camera, and thus the imaging area of the fisheye camera is accurately calibrated when the images are shot by the fisheye camera.

### CROSS-REFERENCE TO RELATED APPLICATIONS

This application is a continuation of International Application No. PCT/CN2024/078844, filed on Feb. 27, 2024, which claims priority to Chinese Patent Application No. “202310229365.0”, filed on Feb. 28, 2023. The disclosures of the aforementioned applications are hereby incorporated by reference in their entireties.

### TECHNICAL FIELD

This application relates to the technical field of fisheye image processing, and more particularly relates to a fisheye image processing method, an electronic device, and a computer-readable storage medium.

### BACKGROUND

When determining an effective imaging area of a fisheye image shot by a camera, restricted by differences between different shooting scenes (light conditions and exposure parameters of the camera), relatively large differences between the fisheye images are caused. However, the current methods for preprocessing the fisheye images are difficult to adapt to different scenes and different exposure parameters, thereby resulting in the unstable accuracy of subsequent determination of the effective imaging area based on the preprocessed image.

### SUMMARY

Embodiments of this application provide a fisheye image processing method, an electronic device, and a computer-readable storage medium.

In a first aspect, an embodiment of this application provides a fisheye image processing method. The method includes: acquiring a fisheye image shot by a fisheye camera; performing color space transformation on the fisheye image to generate a grayscale image; respectively calculating a derivative of each pixel in the grayscale image in a horizontal direction to generate a first gradient image, and respectively calculating a derivative of each pixel in the grayscale image in a perpendicular direction to generate a second gradient image; respectively calculating an azimuthal angle corresponding to each of first pixels according to each of the first pixels of the first gradient image and a second pixel at a same position as the first pixel in the second gradient image, and performing normalization processing on the azimuthal angles to generate an azimuthal image according to the azimuthal angles after normalization processing; and determining an effective imaging area of the fisheye camera according to the azimuthal image.

In the embodiment, the determining an effective imaging area of the fisheye camera according to the azimuthal image, includes: determining a plurality of angular offsets within a preset interval based on a preset step length; respectively adding the angular offset to each of the azimuthal angles in the azimuthal image to generate an offset image corresponding to each of the angular offsets; respectively performing binarization processing on each of the offset images to generate a binarized image corresponding to each of the offset images; and determining the effective imaging area according to a plurality of binarized images.

In the embodiment, the respectively adding the angular offset to each of the azimuthal angles in the azimuthal image to generate an offset image corresponding to each of the angular offsets, includes: respectively adding the angular offset to each of the azimuthal angles in the azimuthal image; under the condition that a numerical value obtained by adding the angular offset to the azimuthal angle is greater than or equal to a preset threshold, decreasing the numerical value by the preset threshold; and generating the offset image corresponding to each of the angular offsets according to the azimuthal image added with the angular offset.

In the embodiment, before determining the effective imaging area according to a plurality of binarized images, the fisheye image processing method includes: respectively performing median filtering on each of the binarized images; wherein the determining the effective imaging area according to a plurality of binarized images, includes: determining the effective imaging area according to the plurality of binarized images after median filtering.

In the embodiment, the determining the effective imaging area according to a plurality of binarized images, includes: accumulating pixel values of pixels at a same position in the plurality of binarized images to generate a statistical image; performing normalization processing on each pixel in the statistical image; performing binarization processing on the statistical image after normalization processing; performing median filtering on the statistical image after binarization processing; and determining the effective imaging area according to the statistical image after median filtering.

In the embodiment, the accumulating pixel values of pixels at a same position in the plurality of binarized images to generate a statistical image, includes: respectively accumulating pixel values of pixels at the same position in the plurality of binarized images to generate a plurality of accumulated pixel values; determining an accumulated number of pixels of preset pixel values corresponding to the accumulated pixel values according to a quotient of the accumulated pixel values and the preset pixel values; and generating the statistical image according to the accumulated number.

In the embodiment, the determining the effective imaging area according to the statistical image after median filtering, includes: performing progressive scanning on the statistical image after median filtering to obtain boundary pixels having pixel values in each row being preset pixel values; and determining the effective imaging area according to image coordinates of all of the boundary pixels.

In second aspect, an embodiment of this application further provides an electronic device. The electronic device includes: one or more processors, a memory and one or more programs, wherein the one or more programs are stored in the memory and executed by the one or more processors, and the programs include instructions for executing the fisheye image processing method according to any one of the embodiments described above.

In third aspect, an embodiment of this application further provides a non-transitory computer-readable storage medium. The medium includes: a computer program, wherein the computer program, when executed by a processor, causes the processor to execute the fisheye image processing method according to any one of the embodiments described above.

For the fisheye image processing method, the electronic device, and the computer-readable storage medium according to the embodiments of this application, by acquiring a single-channel grayscale image obtained by performing color space transformation on the fisheye image, and respectively generating the first gradient image and the second gradient image based on the derivatives of the grayscale image in the horizontal direction and the perpendicular direction, the azimuthal angle corresponding to each of first pixels is determined according to any one of the first pixels in the first gradient image and the second pixel at the same position as the first pixel in the second gradient image, so as to generate the azimuthal image according to the azimuthal angle corresponding to each of the first pixels, and finally the determination of the effective imaging area is achieved based on the azimuthal image. For the fisheye camera, since a grayscale change trend between different image areas of the fisheye images shot in different shooting scenes is unchanged, for example, the grayscale change trend from four corners to the center of the fisheye camera is unchanged, the azimuthal image determined based on the first gradient image and the second gradient image can adapt to different shooting scenes, thereby ensuring the accuracy of the effective imaging area determined based on the azimuthal image.

Additional aspects and advantages of the embodiments of this application will be set forth in part in the description below, and will become apparent in part from the description below, or may be learned by practice of the embodiments of this application.

### BRIEF DESCRIPTION OF THE DRAWINGS

The foregoing and/or additional aspects and advantages of this application will become apparent and readily understood from the description of the embodiments in conjunction with the following accompanying drawings, in which:

FIG. 1 is a schematic flowchart of a fisheye image processing method according to an embodiment of this application;

FIG. 2 is a schematic scene diagram of the fisheye image processing method according to an embodiment of this application;

FIG. 3 is a schematic diagram of an azimuthal image of the fisheye image processing method according to an embodiment of this application;

FIG. 4 is a schematic flowchart of the fisheye image processing method according to an embodiment of this application;

FIG. 5 is a schematic diagram of a binarized image with an angular offset of 0 of the fisheye image processing method according to an embodiment of this application;

FIG. 6 is a schematic diagram of a binarized image with an angular offset of 60 of the fisheye image processing method according to an embodiment of this application;

FIG. 7 is a schematic diagram of a binarized image with an angular offset of 120 of the fisheye image processing method according to an embodiment of this application;

FIG. 8 is a schematic diagram of a binarized image with an angular offset of 180 of the fisheye image processing method according to an embodiment of this application;

FIG. 9 is a schematic flowchart of the fisheye image processing method according to an embodiment of this application;

FIG. 10 is a schematic diagram of a statistical image of the fisheye image processing method according to an embodiment of this application;

FIG. 11 is a schematic flowchart of the fisheye image processing method according to an embodiment of this application;

FIG. 12 is a schematic plan diagram of an electronic device according to an embodiment of this application; and

FIG. 13 is a schematic diagram of a connection state of a non-volatile computer-readable storage medium and a processor according to an embodiment of this application.

### DETAILED DESCRIPTION

The embodiments of this application will be described in detail below, and examples of the embodiments are illustrated in the accompanying drawings, wherein the same or similar reference numerals indicate the same or similar elements or the elements having same or similar functions throughout the drawings. The embodiments described below with reference to the accompanying drawings are exemplary only to explain the embodiments of this application and should not be construed as limiting the embodiments of this application.

A fisheye camera has been widely applied because of the advantage of a large and wide angle. However, in many image analysis scenes such as automatic driving, intelligent monitoring and other fields, there are relatively strict requirements for input image distortion, an original photograph must be restored by a specific anti-distortion correction algorithm, and generally an effective imaging area is accurately calibrated before delivery. However, in application scenes such as automatic driving and three-dimensional reconstruction, there are a large number of scenes which still need to be calibrated after delivery: for example, damage and replacement of a camera caused by a collision accident of a vehicle, displacement after bumping and squeezing during long-distance transportation of an unmanned distribution vehicle, and the like. However, after delivery, in the absence of a standard test environment, if the effective imaging area is to be determined, the determination can be performed only based on the images collected by the fisheye camera in actual using scenes. Due to the change of shooting scenes, there is a relatively large difference between the collected fisheye images. However, the current methods for preprocessing the fisheye images are difficult to adapt to different scenes and different exposure parameters, thereby resulting in the unstable accuracy of subsequent determination of the effective imaging area based on the preprocessed image.

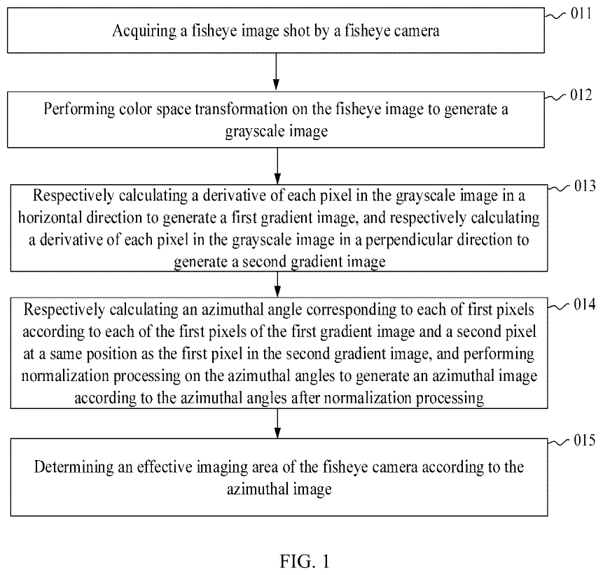

With reference to FIG. 1, an embodiment of this application provides a fisheye image processing method, including.

Step 011: acquiring a fisheye image shot by a fisheye camera.

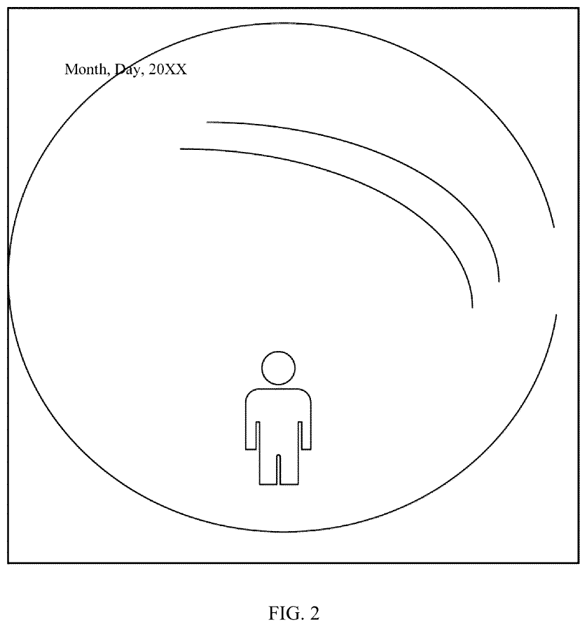

The fisheye camera may be a fisheye camera, it can be understood that the fisheye camera may also be other types of cameras, such as a wide-angle camera and a long-focus camera, and this application is illustrated by taking the fisheye camera for an example. As shown in FIG. 2, the effective imaging area of the fisheye camera is generally circular, the finally output fisheye image is generally rectangular, the fisheye image further includes Over Screen Display (OSD) contents (such as Month, Day, 20XX in FIG. 2) in addition to containing the effective imaging area, and the OSD contents are related to actual application scenes of the fisheye camera.

Since four corner areas of the fisheye image are areas without scene information, the four corners of the fisheye image are always black, while the image in the effective imaging area contains brightness information of the actual scene, the grayscale change trend from the four corners to the effective imaging area is unchanged, namely, the grayscale from the four corners to the effective imaging area is increased regardless of which shooting scene.

The fisheye image is an image collected by the fisheye camera which has not been processed, and the fisheye image may be an image obtained by shooting in any shooting scene, or with any shooting parameter (such as an exposure parameter), which is not limited in this application.

In order to achieve the calibration of an effective normal area of the fisheye camera, the fisheye image shot by the fisheye camera needs to be firstly acquired, so as to preprocess the fisheye image.

Step 012: performing color space transformation on the fisheye image to generate a grayscale image.

The fisheye image is generally a visible light image (such as a red, green and blue (namely, RGB) three-channel image), and the color space transformation may be performing color space transformation on the fisheye image by a Hue, Saturation, Value (HSV) color model, so as to calculate the Hue (H), Saturation(S) and Value (V) of each pixel according to three-channel pixel values (namely, an R-channel pixel value, a G-channel pixel value and a B-channel pixel value) of each pixel, and then generate the grayscale image according to the Value of each pixel.

Step 013: respectively calculating a derivative of each pixel in the grayscale image in a horizontal direction to generate a first gradient image, and respectively calculating a derivative of each pixel in the grayscale image in a perpendicular direction to generate a second gradient image.

After obtaining the grayscale image, it can be seen from the foregoing discussion that the grayscale change trend from the four corners to the effective imaging area of the fisheye camera is unchanged, namely, the gradient change of the grayscale is unchanged, and therefore the grayscale of the grayscale image in different directions is calculated, so as to obtain a plurality of gradient images. For example, the acquisition of the gradient images may be specifically achieved by a canny operator.

According to the arrangement of the pixels, generally the gradient in the horizontal direction and the gradient in the perpendicular direction of the fisheye image are respectively calculated, so as to respectively obtain the first gradient image and the second gradient image with perpendicular gradient directions.

Optionally, when determining the first gradient image, the derivative of each pixel in the grayscale image in the horizontal direction is respectively calculated, so as to obtain the gradient of the grayscale image in the horizontal direction to generate the first gradient image; and when determining the second gradient image, the derivative of each pixel in the grayscale image in the perpendicular direction is respectively calculated, so as to obtain the gradient of the grayscale image in the perpendicular direction to generate the second gradient image.

Step 014: respectively calculating an azimuthal angle corresponding to each of first pixels according to each of the first pixels of the first gradient image and a second pixel at a same position as the first pixel in the second gradient image, and performing normalization processing on the azimuthal angles to generate an azimuthal image according to the azimuthal angles after normalization processing.

After determining the first gradient image and the second gradient image, the azimuthal image is generated according to the first gradient image and the second gradient image.

The first gradient image includes a plurality of first pixels, the second gradient image includes a plurality of second pixels. The azimuthal image includes a plurality of third pixels, and pixel values of the third pixels are the azimuthal angles. The first pixels, the second pixels and the third pixels are in one-to-one correspondence, and positions of the first pixels, the second pixels and the third pixels which are in one-to-one correspondence are the same.

The third pixels at the same positions in the azimuthal image are determined according to the first pixels and the second pixels at the same positions. For example, the azimuthal angle corresponding to the first pixel is calculated according to the pixel value of the first pixel and the pixel value of the second pixel at the same position, and an arctan function. Namely, the pixel value of the third pixel corresponding to each of the first pixels is calculated, so as to generate the azimuthal image according to the pixel value of each of the third pixels, and the azimuthal angle is located within an interval of [0, 360 degrees], while image processing is generally performed based on an 8-bit data structure. Therefore, it is necessary to perform normalization processing on the azimuthal image, so as to normalize all the azimuthal angles to a preset azimuthal angle interval, for example, the preset azimuthal angle interval may be [0, 255]. It can be understood that the preset azimuthal angle interval may also be other ranges, and the preset azimuthal angle interval may be determined according to the number of bits of image processing, which is not limited herein. The azimuthal angle is used for indicating the gradient change direction of the grayscale of each of the third pixels.

In this way, the azimuthal image is generated by the first gradient image and the second gradient image to indicate the change trend of the pixels, thereby facilitating subsequent determination of the effective imaging area of the fisheye camera according to the azimuthal image.

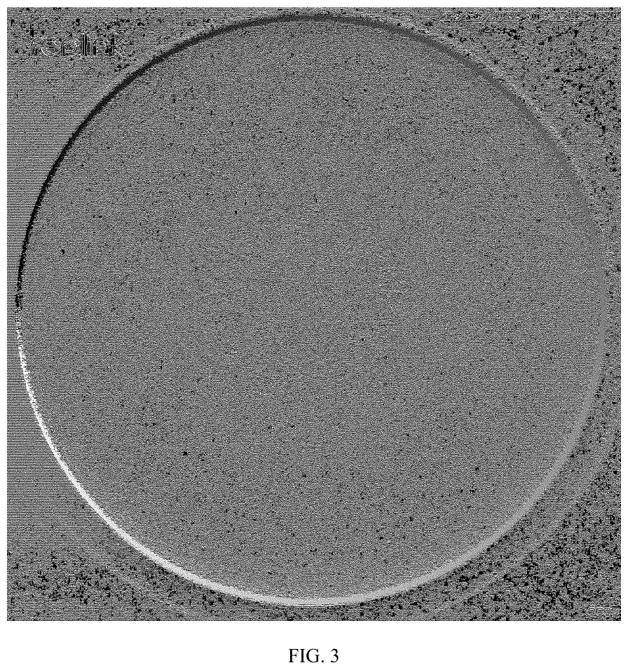

FIG. 3 is an azimuthal image generated according to the first gradient image and the second gradient image, wherein the pixel values of different third pixels indicate the sizes of the azimuthal angles of the pixels.

Step 015: determining an effective imaging area of the fisheye camera according to the azimuthal image. In the embodiment of this application, the anti-distortion correction for the fisheye camera is performed in the process of shooting images according to the effective imaging area of the fisheye camera, and thus the imaging area of the fisheye camera is accurately calibrated when the images are shot by the fisheye camera.

After determining the azimuthal image, the azimuthal image can be detected to determine the effective imaging area. For example, edge detection is performed on the azimuthal image, and for example, in FIG. 3, a circular contour of the effective imaging area can be clearly seen, so as to obtain the effective imaging area. Since the grayscale change trend from the four corners to the center of the fisheye camera is unchanged in different shooting scenes, the azimuthal image determined based on the gradient images can adapt to different shooting scenes, thereby ensuring the accuracy of the effective imaging area determined based on the azimuthal image.

For the fisheye image processing method according to the embodiment of this application, by acquiring a single-channel grayscale image obtained by performing color space transformation on the fisheye image, and respectively generating the first gradient image and the second gradient image based on the derivatives of the grayscale image in the horizontal direction and the perpendicular direction, the azimuthal angle corresponding to each of first pixels is determined according to any one of the first pixels in the first gradient image and the second pixel at the same position as the first pixel in the second gradient image, so as to generate the azimuthal image according to the azimuthal angle corresponding to each of the first pixels, and finally the determination of the effective imaging area is achieved based on the azimuthal image. For the fisheye camera, since a grayscale change trend between different image areas of the fisheye images shot in different shooting scenes is unchanged, for example, the grayscale change trend from four corners to the center of the fisheye camera is unchanged, the azimuthal image determined based on the first gradient image and the second gradient image can adapt to different shooting scenes, thereby ensuring the accuracy of the effective imaging area determined based on the azimuthal image.

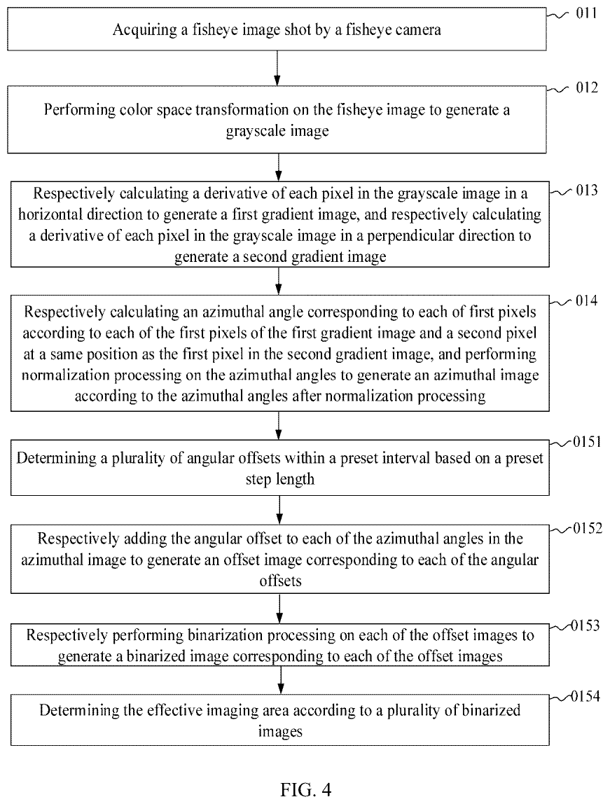

With reference to FIG. 4, step 015: determining an effective imaging area of the fisheye camera according to the azimuthal image, includes:
step 0151: determining a plurality of angular offsets within a preset interval based on a preset step length;
step 0152: respectively adding the angular offset to each of the azimuthal angles in the azimuthal image to generate an offset image corresponding to each of the angular offsets;
step 0153: respectively performing binarization processing on each of the offset images to generate a binarized image corresponding to each of the offset images; and
step 0154: determining the effective imaging area according to a plurality of binarized images.

After determining the azimuthal image, the azimuthal image needs to be offset based on different angular offsets, so as to highlight the third pixels located near the edge of the effective imaging area at different angular offsets.

Therefore, a plurality of angular offsets can be determined within a preset interval (for example, the preset interval is [0, 360]), for example, the angular offsets such as 0, 30, 50, 80, 110, and the like are immediately determined, so that the plurality of angular offsets are distributed within the whole preset interval as much as possible. Further, a plurality of angular offsets can also be determined within the preset interval based on the preset step length, for example, the preset interval is [0, 360], and for example, the preset step length is 10, 30, 50, 60, and the like, and then the plurality of angular offsets can be obtained. For example, by taking the preset step length being 30 as an example, 13 angular offsets which are respectively 0, 30, 60, 90, . . . , 360 can be obtained, so as to cover the whole preset interval. In this case, after the plurality of angular offsets are arranged in sequence from small to large, a difference value between any two adjacent angular offsets is the same and is the preset step length, so that the plurality of angular offsets are uniformly distributed within the whole preset interval, thereby being beneficial to improving the accuracy of the offset images subsequently processed based on the angular offsets.

The azimuthal image is processed according to each of the angular offsets respectively to generate the offset image corresponding to each of the angular offsets. For example, the offset image is determined according to the following formula:

I2(x, y)=I1(x, y)+α,

wherein I2 is the offset image, I1 is the azimuthal image, (x, y) is the image coordinate, (x, y) is located within the range of the image coordinate of the azimuthal image, I2 (x, y) indicates fourth pixels with image coordinates being (x, y), I1 (x, y) indicates third pixels with image coordinates being (x, y), and α is the angular offset. That is to say, the angular offset can be added to the pixel value of each of the third pixels in the azimuthal image to obtain the pixel value of the fourth pixel corresponding to each of the third pixels and generate the offset image corresponding to the angular offset according to the pixel values of a plurality of fourth pixels. In this way, the offset image corresponding to each of the angular offsets is obtained, namely, a total of 13 offset images.

In addition, the pixel value of the fourth pixel obtained by adding the angular offset to the pixel value of the third pixel may be greater than or equal to a preset threshold (for example, the preset threshold is 256), which does not meet the data requirements of image processing, and thus processing is needed. For the fourth pixel having a pixel value greater than 255, the pixel value of the fourth pixel is replaced according to the difference value between the pixel value of the fourth pixel and the preset threshold, thereby ensuring that the pixel values of all of the fourth pixels are less than or equal to 255. Therefore, for the fourth pixel having a pixel value greater than 255, the preset threshold (such as 256) is subtracted from the pixel value of the fourth pixel, and it can be understood that for an angle exceeding 360, the angle obtained by subtracting 360 is actually the same, such as 30 degrees and 390 degrees. Therefore, after subtracting 256 from the pixel value of the fourth pixel having a pixel value exceeding 255, the corresponding azimuthal angle is actually unchanged, without affecting the accuracy of the azimuthal angle.

In order to facilitate data processing, improve the efficiency of data processing, and enable the characters of the effective imaging area to be more obvious, binarization processing can be performed on each of the offset images, so as to obtain a plurality of binarized images. Under the condition that the pixel values of the fourth pixels of the offset images are all located within the interval of [0, 255], 200 may be a threshold, so that the pixels having the pixel values greater than 200 are assigned a value of 255,while the pixels having the pixel values less than or equal to 200 are assigned a value of 0, so as to form a black-and-white binarized image. After binarizing the 13 offset images respectively, 13 binarized images are obtained.

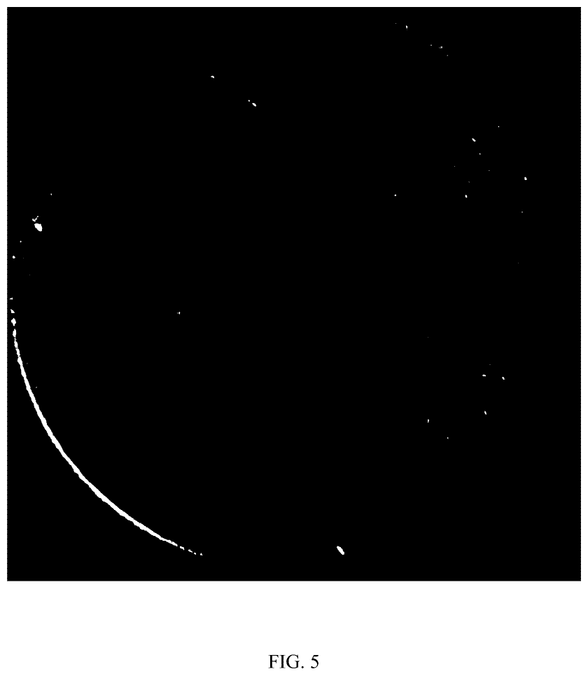

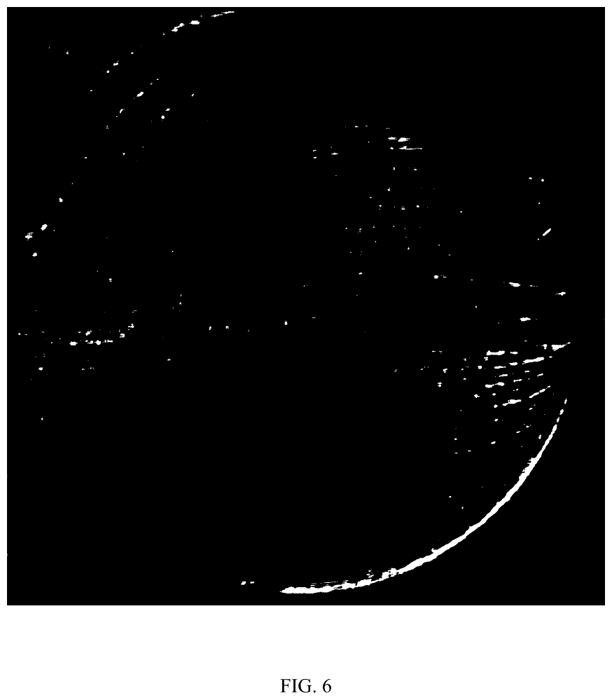

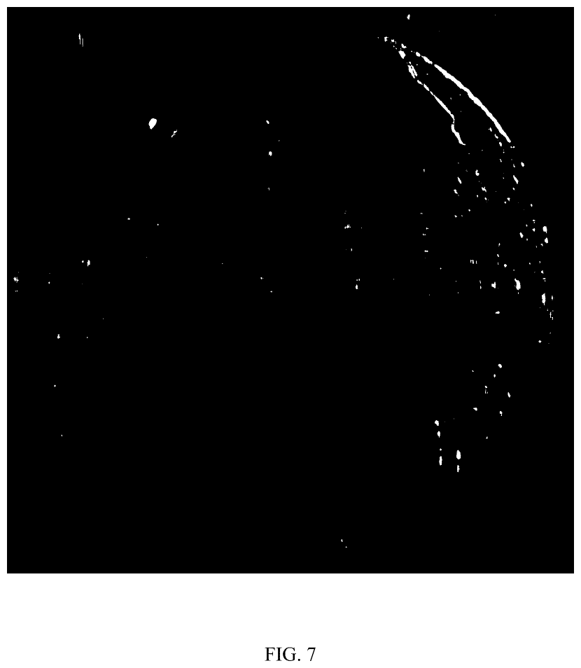

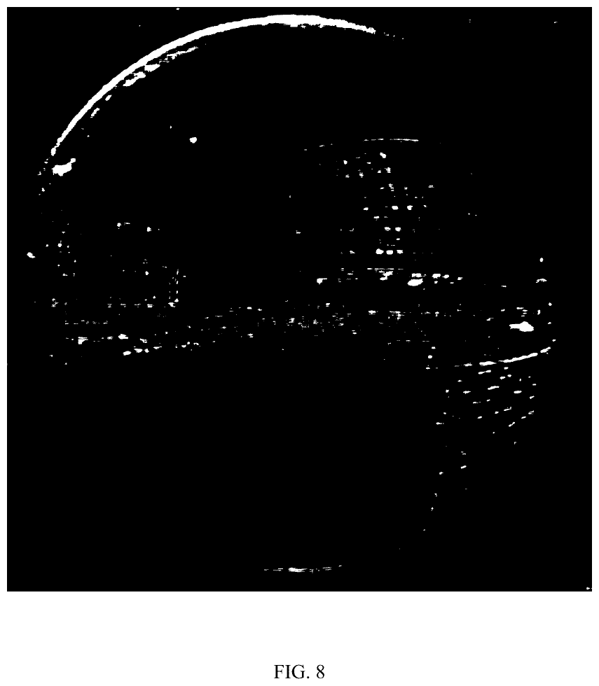

FIG. 5 to FIG. 8 are binarized images with the angular offsets of 0, 60, 120 and 180 respectively. For brevity, the 13 binarized images are not shown in their entirety, but only a part of the binarized images with the angular offsets are shown. It can be understood that since the offset image is obtained by angularly offsetting the azimuthal image after performing binarization, the areas exhibiting white are different. For example, for the azimuthal images corresponding to different shooting scenes, edge portions of the effective imaging areas at the lower left corner are all azimuthal angles close to 360 degrees, and therefore, after performing binarization on the offset image at 0 degree, substantially only the edge portions of the effective imaging area at the lower left corner in the offset image exhibit white to form a white arc. By the same reasoning, after performing the angular offsets, images of the edge portions of the effective imaging area corresponding to different angular offsets are obtained, so that after all the images of the edge portions of the effective imaging area within the preset interval (namely, within 0 to 360 degrees) are obtained, the effective imaging area is determined according to a plurality of binarized images corresponding to a plurality of offset images.

Optionally, median filtering may be performed on each of the binarized images respectively to obtain the filtered binarized image, thereby reducing the influence of discrete noise pixels on the subsequent determination of the effective imaging area. The effective imaging area is then accurately determined according to a plurality of binarized images after median filtering.

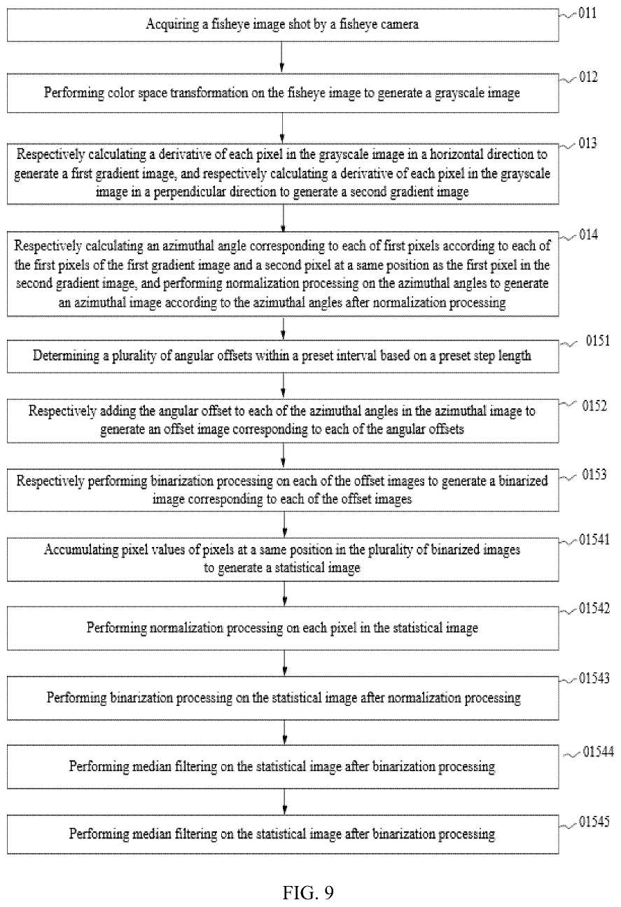

With reference to FIG. 9, step 0154: determining the effective imaging area according to a plurality of binarized images, includes:

step 01541: accumulating pixel values of pixels at a same position in the plurality of binarized images to generate a statistical image;

step 01542: performing normalization processing on each pixel in the statistical image;

step 01543: performing binarization processing on the statistical image after normalization processing;

step 01544: performing median filtering on the statistical image after binarization processing; and

step 01545: determining the effective imaging area according to the statistical image after median filtering.

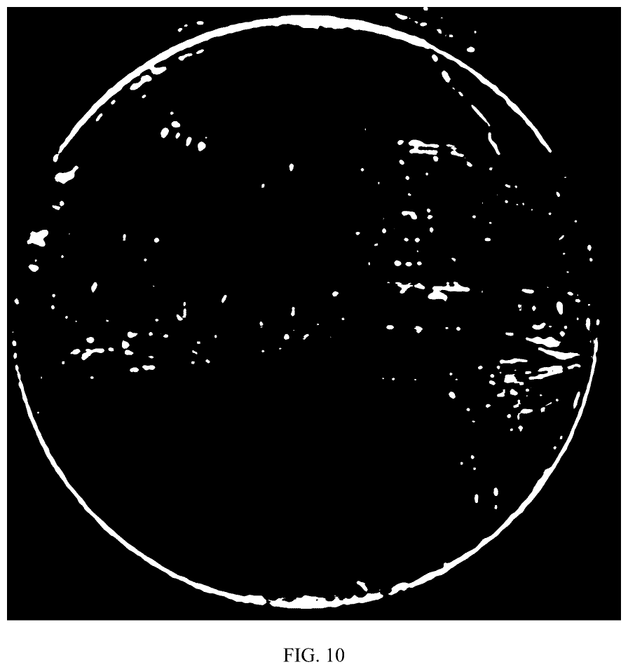

With reference to FIG. 10, after obtaining a plurality of binarized images corresponding to different angular offsets, it can be clearly seen that a corresponding white pixel area in each binarized image is a part of the effective imaging area, and therefore the statistical image is generated according to the pixel values of the pixels at the same positions in a plurality of binarized images (or a plurality of binarized images after median filtering), so as to form a complete effective imaging area.

For example, the pixel values of the pixels at the same positions in a plurality of binarized images are respectively accumulated to determine a plurality of accumulated pixel values, so as to generate the statistical image according to the accumulated pixel values. It can be understood that there are pixels having the pixel values exceeding 255 in the statistical image, and in order to facilitate subsequent image processing, normalization processing may be performed on the statistical image, so that the pixel values of the pixels of the statistical image are located within the preset interval (such as [0, 255]). Or according to the quotient of the accumulated pixel values and pixel values (namely, preset pixel values) of white pixels in the binarized images, each of the accumulated pixel values being formed by accumulating the pixel values of how many white pixels is determined. Namely, the accumulated number of the white pixels corresponding to each of the accumulated pixel values is determined, and the statistical image is generated according to the accumulated number corresponding to each of the accumulated pixel values. In this case, the pixel value of each pixel in the statistical image is the number of the white pixels at the same position in a plurality of binarized images, and in order to facilitate subsequent image processing, normalization processing is performed on the statistical image, so that the pixel values of the pixels of the statistical image are located within the preset interval (such as [0, 255]).

After normalizing the statistical image, binarization processing may be performed on the normalized statistical image again by using a threshold, so as to obtain the binarized image corresponding to the statistical image, so that the effective imaging area is exhibited in the binarized image corresponding to the statistical image. As shown in FIG. 10, it can be clearly seen that the contour of the effective imaging area in the binarized image corresponding to the statistical image has been relatively obvious, and therefore the effective imaging area can be quickly and accurately determined subsequently based on the statistical image.

Optionally, for the statistical image or the binarized image corresponding to the statistical image, median filtering may also be performed to eliminate discrete noisy point pixels in the image, thereby improving the accuracy of subsequent determination of the effective imaging area.

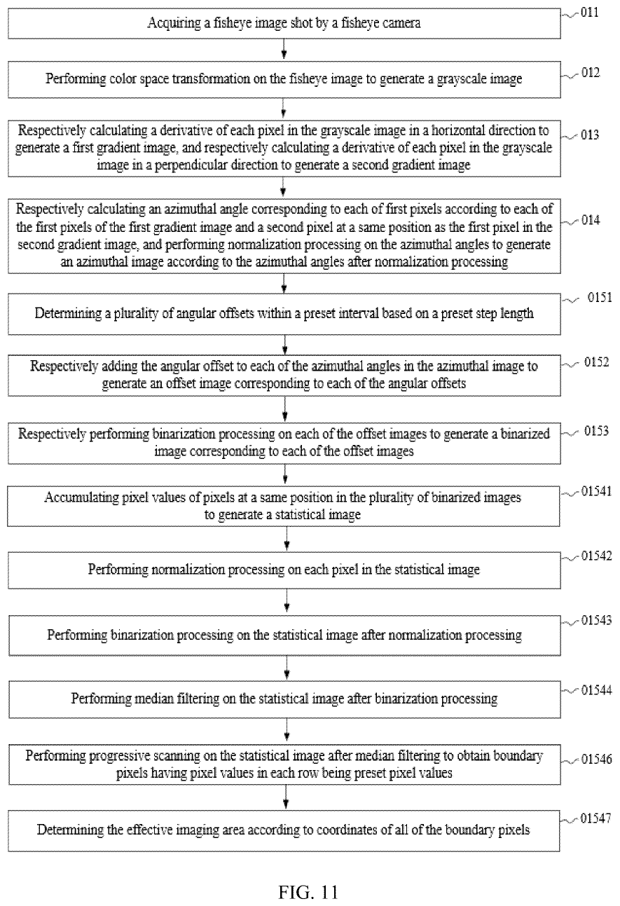

With reference to FIG. 11, step 01545: determining the effective imaging area according to the statistical image after median filtering, includes:
step 01546: performing progressive scanning on the statistical image after median filtering to obtain boundary pixels having pixel values in each row being preset pixel values; and
step 01547: determining the effective imaging area according to coordinates of all of the boundary pixels.

After determining the statistical image, the effective imaging area can be determined according to the statistical image after binarization processing (or the statistical image after median filtering).

For example, progressive scanning is performed on the statistical image after median filtering to obtain boundary pixels having pixel values in each row being preset pixel values (such as 255); and for example, the boundary pixels are pixels having first and last pixel values in each row of pixels being preset pixel values (such as 255), namely, the first white pixel and the last white pixel in each row of pixels, so as to obtain all of the boundary pixels in the statistical image after binarization processing (or the statistical image after median filtering), and the effective imaging area can be determined according to image coordinates of all of the boundary pixels.

For example, a nonlinear optimization error equation can be constructed according to the image coordinates of all of the boundary pixels and preset parameters to be solved, and the reset parameters to be solved include the image coordinate of the center of circle and the radius of the effective imaging area. By solving the optimal solution for the nonlinear optimization error equation, the image coordinate of the center of circle and the radius of the effective imaging area are obtained, so as to determine the effective imaging area. In the embodiment of this application, the anti-distortion correction for the fisheye camera is performed in the process of shooting images according to the effective imaging area of the fisheye camera, and thus the imaging area the of fisheye camera is accurately calibrated when the images are shot by the fisheye camera.

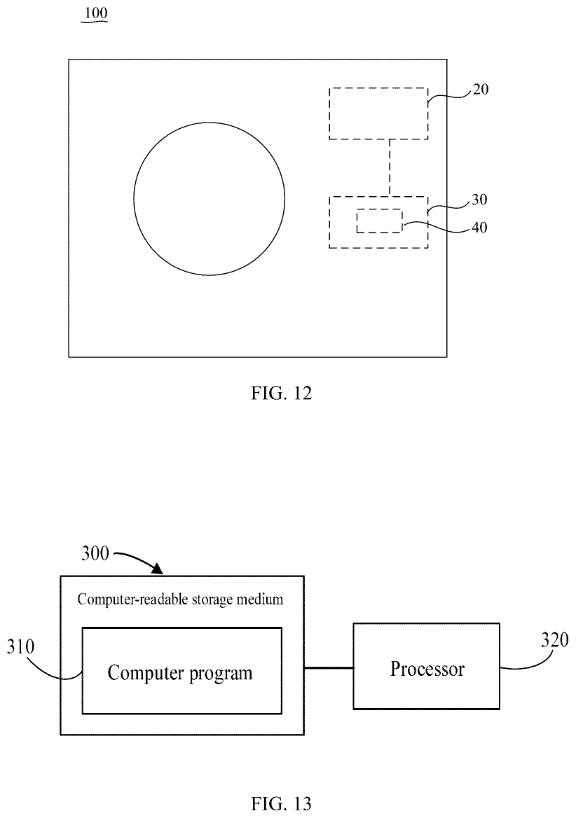

With reference to FIG. 12, the electronic device 100 according to the embodiment of this application includes one or more processors 20, and a memory 30 configured to store one or more computer programs 40, wherein the one or more processors 20 is coupled to the memory 30, and the one or more programs 40 are stored in the memory 30 and executed by the one or more processors 20, and the computer programs 40 include a plurality of computer-readable instructions for executing the fisheye image processing method according to any one of the embodiments described above.

Wherein the electronic device 100 may be a fisheye camera or a back-end server device communicated with the fisheye camera, a mobile phone, a tablet computer, a notebook computer, a smart watch, and the like. As shown in FIG. 12, the embodiment of this application is described by taking the fisheye camera as the electronic device 100 for an example, and it can be understood that the specific form of the electronic device 100 is not limited to the fisheye camera. For the fisheye camera of this application, image processing may be performed based on the fisheye image after acquiring the fisheye image to obtain the azimuthal image, thereby facilitating the anti-distortion correction of the fisheye camera at any time in the process of use.

With reference to FIG. 13, an embodiment of this application further provides a non-transitory computer-readable storage medium 300 having a computer program 310 stored thereon, wherein the computer program 310, when executed by a processor 320, implements the steps of the fisheye image processing method according to any one of the embodiments described above, which is not described in detail herein for brevity.

The skilled in the art can understand that the above-mentioned computer-readable instructions can be stored in a computer-readable storage medium, if the computer instructions are implemented in a form of software functional modules and sold or used as independent products. Based on this understanding, the technical solution of this application, in essence, or a part that contributes to the prior art, or all or part of the technical solution can be embodied in a form of a software product. A computer software product is stored in a storage medium, including several instructions for an electronic device (which can be a fisheye camera, a type of camera device, or a computing device, etc.) to perform all or part of the steps of the method described in each embodiment of this application. The aforementioned storage medium is a RAM, a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

Any process or method description in a flowchart or otherwise described herein may be understood to represent a module, segment or portion including codes of one or more executable instructions for implementing the steps of a particular logical function or process, and the scope of the preferred embodiments of this application includes additional implementations, wherein functions may be executed in substantially the same way or in a reverse order, not in the order illustrated or discussed, including according to the functions referenced, as will be understood by those skilled in the art to which the examples of this application pertain.

Although the embodiments of this application have been illustrated and described above, it can be understood that the embodiments described above are exemplary and are not to be construed as limiting this application, and variations, modifications, substitutions and alterations may be made to the embodiments described above by those ordinarily skilled in the art within the scope of this application.

What is claimed is:

1. A fisheye image processing method, comprising:
acquiring a fisheye image shot by a fisheye camera;
performing color space transformation on the fisheye image to generate a grayscale image;
respectively calculating a derivative of each pixel in the grayscale image in a horizontal direction to generate a first gradient image, and respectively calculating a derivative of each pixel in the grayscale image in a perpendicular direction to generate a second gradient image;
respectively calculating an azimuthal angle corresponding to each of first pixels according to each of the first pixels of the first gradient image and a second pixel at a same position as the first pixel in the second gradient image, and performing normalization processing on the azimuthal angles to generate an azimuthal image according to the azimuthal angles after normalization processing; and
determining an effective imaging area of the fisheye camera according to the azimuthal image.

2. The fisheye image processing method according to claim 1, wherein the determining an effective imaging area of the fisheye camera according to the azimuthal image, comprises:
determining a plurality of angular offsets within a preset interval based on a preset step length;
respectively adding the angular offset to each of the azimuthal angles in the azimuthal image to generate an offset image corresponding to each of the angular offsets;
respectively performing binarization processing on each of the offset images to generate a binarized image corresponding to each of the offset images; and
determining the effective imaging area according to a plurality of binarized images.

3. The fisheye image processing method according to claim 2, wherein the respectively adding the angular offset to each of the azimuthal angles in the azimuthal image to generate an offset image corresponding to each of the angular offsets, comprises:
respectively adding the angular offset to each of the azimuthal angles in the azimuthal image;
under the condition that a numerical value obtained by adding the angular offset to the azimuthal angle is greater than or equal to a preset threshold, decreasing the numerical value by the preset threshold; and
generating the offset image corresponding to the angular offset according to the azimuthal image added with the angular offset.

4. The fisheye image processing method according to claim 2, further comprising:
respectively performing median filtering on each of the binarized images; and
wherein the effective imaging area is determined according to the plurality of binarized images after median filtering.

5. The fisheye image processing method according to claim 2, wherein the determining the effective imaging area according to a plurality of binarized images, comprises:
accumulating pixel values of pixels at a same position in the plurality of binarized images to generate a statistical image;
performing normalization processing on each pixel in the statistical image;
performing binarization processing on the statistical image after normalization processing;
performing median filtering on the statistical image after binarization processing; and
determining the effective imaging area according to the statistical image after median filtering.

6. The fisheye image processing method according to claim 5, wherein the accumulating pixel values of pixels at a same position in the plurality of binarized images to generate a statistical image, comprises:
respectively accumulating pixel values of pixels at the same position in the plurality of binarized images to generate a plurality of accumulated pixel values;
determining an accumulated number of pixels of preset pixel values corresponding to the accumulated pixel values according to a quotient of the accumulated pixel values and the preset pixel values; and
generating the statistical image according to the accumulated number.

7. The fisheye image processing method according to claim 5, wherein the determining the effective imaging area according to the statistical image after median filtering, comprises:
performing progressive scanning on the statistical image after median filtering to obtain boundary pixels having pixel values in each row being preset pixel values; and
determining the effective imaging area according to image coordinates of all of the boundary pixels.

8. An electronic device, comprising:
a memory configured to store one or more computer programs comprising a plurality of computer-readable instructions; and
one or more processors coupled to the memory and configured to read the computer-readable instructions, wherein the computer-readable instructions, when executed by the one or more processors, cause the electronic device to perform a fisheye image processing method, the method comprising:
acquiring a fisheye image shot by a fisheye camera;
performing color space transformation on the fisheye image to generate a grayscale image;
respectively calculating a derivative of each pixel in the grayscale image in a horizontal direction to generate a first gradient image, and respectively calculating a derivative of each pixel in the grayscale image in a perpendicular direction to generate a second gradient image;
respectively calculating an azimuthal angle corresponding to each of first pixels according to each of the first pixels of the first gradient image and a second pixel at a same position as the first pixel in the second gradient image, and performing normalization processing on the azimuthal angles to generate an azimuthal image according to the azimuthal angles after normalization processing; and
determining an effective imaging area of the fisheye camera according to the azimuthal image.

9. The electronic device according to claim 8, wherein the determining an effective imaging area of the fisheye camera according to the azimuthal image, comprises:
determining a plurality of angular offsets within a preset interval based on a preset step length;
respectively adding the angular offset to each of the azimuthal angles in the azimuthal image to generate an offset image corresponding to each of the angular offsets;
respectively performing binarization processing on each of the offset images to generate a binarized image corresponding to each of the offset images; and
determining the effective imaging area according to a plurality of binarized images.

10. The electronic device according to claim 9, wherein the respectively adding the angular offset to each of the azimuthal angles in the azimuthal image to generate an offset image corresponding to each of the angular offsets, comprises:
respectively adding the angular offset to each of the azimuthal angles in the azimuthal image;
under the condition that a numerical value obtained by adding the angular offset to the azimuthal angle is greater than or equal to a preset threshold, decreasing the numerical value by the preset threshold; and
generating the offset image corresponding to the angular offset according to the azimuthal image added with the angular offset.

11. The electronic device according to claim 9, wherein the method further comprises:
respectively performing median filtering on each of the binarized images; and
wherein the effective imaging area is determined according to the plurality of binarized images after median filtering.

12. The electronic device according to claim 9, wherein the determining the effective imaging area according to a plurality of binarized images, comprises:
accumulating pixel values of pixels at a same position in the plurality of binarized images to generate a statistical image;
performing normalization processing on each pixel in the statistical image;
performing binarization processing on the statistical image after normalization processing;
performing median filtering on the statistical image after binarization processing; and
determining the effective imaging area according to the statistical image after median filtering.

13. The electronic device according to claim 12, wherein the accumulating pixel values of pixels at a same position in the plurality of binarized images to generate a statistical image, comprises:
respectively accumulating pixel values of pixels at the same position in the plurality of binarized images to generate a plurality of accumulated pixel values;
determining an accumulated number of pixels of preset pixel values corresponding to the accumulated pixel values according to a quotient of the accumulated pixel values and the preset pixel values; and
generating the statistical image according to the accumulated number.

14. The electronic device according to claim 12, wherein the determining the effective imaging area according to the statistical image after median filtering, comprises:
performing progressive scanning on the statistical image after median filtering to obtain boundary pixels having pixel values in each row being preset pixel values; and
determining the effective imaging area according to image coordinates of all of the boundary pixels.

15. A non-transitory computer-readable storage medium having a plurality of computer-readable instructions stored thereon, wherein the computer-readable instructions, when executed by a processor of an electronic device, causes the electronic device to perform a fisheye image processing method, the method comprising:
acquiring a fisheye image shot by a fisheye camera;
performing color space transformation on the fisheye image to generate a grayscale image;
respectively calculating a derivative of each pixel in the grayscale image in a horizontal direction to generate a first gradient image, and respectively calculating a derivative of each pixel in the grayscale image in a perpendicular direction to generate a second gradient image;
respectively calculating an azimuthal angle corresponding to each of first pixels according to each of the first pixels of the first gradient image and a second pixel at a same position as the first pixel in the second gradient image, and performing normalization processing on the azimuthal angles to generate an azimuthal image according to the azimuthal angles after normalization processing; and
determining an effective imaging area of the fisheye camera according to the azimuthal image.

16. The non-transitory computer-readable storage medium according to claim 15, wherein the determining an effective imaging area of the fisheye camera according to the azimuthal image, comprises:
determining a plurality of angular offsets within a preset interval based on a preset step length;
respectively adding the angular offset to each of the azimuthal angles in the azimuthal image to generate an offset image corresponding to each of the angular offsets;
respectively performing binarization processing on each of the offset images to generate a binarized image corresponding to each of the offset images; and
determining the effective imaging area according to a plurality of binarized images.

17. The non-transitory computer-readable storage medium according to claim 16, wherein the respectively adding the angular offset to each of the azimuthal angles in the azimuthal image to generate an offset image corresponding to each of the angular offsets, comprises:
respectively adding the angular offset to each of the azimuthal angles in the azimuthal image;
under the condition that a numerical value obtained by adding the angular offset to the azimuthal angle is greater than or equal to a preset threshold, decreasing the numerical value by the preset threshold; and
generating the offset image corresponding to the angular offset according to the azimuthal image added with the angular offset.

18. The non-transitory computer-readable storage medium according to claim 16, wherein the method further comprises:
respectively performing median filtering on each of the binarized images; and
wherein the effective imaging area is determined according to the plurality of binarized images after median filtering.

19. The non-transitory computer-readable storage medium according to claim 16, wherein the determining the effective imaging area according to a plurality of binarized images, comprises:
accumulating pixel values of pixels at a same position in the plurality of binarized images to generate a statistical image;
performing normalization processing on each pixel in the statistical image;
performing binarization processing on the statistical image after normalization processing;
performing median filtering on the statistical image after binarization processing; and
determining the effective imaging area according to the statistical image after median filtering.

20. The electronic device according to claim 19, wherein the determining the effective imaging area according to the statistical image after median filtering, comprises:
performing progressive scanning on the statistical image after median filtering to obtain boundary pixels having pixel values in each row being preset pixel values; and
determining the effective imaging area according to image coordinates of all of the boundary pixels.
